(19) United States
(12) Patent Application Publication
(10) Pub. No.: US 2007/0113463 A1
(43) Pub. Date: May 24, 2007

(54) Fishing rod carry bag

(76) Inventor: Randy Duncan, Killen, AL (US)

Correspondence Address: David W Barman, 1101 NE 176 Terrace, North Miami Beach, FL, 33162, US

(21) Appl. No.: 11/286,963

(22) Filed: Nov. 23, 2005

(51) Int. Cl. A01K 97/08

(52) U.S. Cl. 43/26

(57) ABSTRACT

The present invention is an apparatus and method for carrying fishing equipment.

### BACKGROUND OF THE INVENTION

This invention relates to a novel bag for the carrying of a fishing rod and reel with related equipment.

The sport of fishing typically entails a lot of equipment and accessory items. The sport of fishing also requires that the equipment and accessory items typically be carried from a vehicle to another site where the fishing will take place. Keeping that equipment organized, clean and under control is often difficult to do.

There is need for an apparatus to transport the fishing rod and reel, while also permitting additional accessory equipment to be carried therewith. There is also a need to carry that fishing rod and reel and related equipment in an efficient and unobtrusive manner as possible because such equipment is awkward in view of its length and dissymmetry thereof.

It is therefore an object of the present invention, to provide a fishing rod and reel carry bag that improves on prior carry bags.

It is a further object of the present invention to provide a carry bag that quickly and easily stores the rod and reel and accessories.

It is yet still a further object of the present invention, to provide a carry bag that will protect the rod and reel and related equipment, from the environment, as well as from sinking it fell into water.

It is still yet a further object of the present invention, to provide a carry bag that is resistant to cuts and provides personal comfort for the fisherman as well as safety for the user and the equipment.

It is still yet a further object of the present invention to further provide a carry bag that is resistant to puncture from fishing hooks.

### BRIEF SUMMARY OF THE INVENTION

The present invention relates to a fishing rod carry bag for enclosing and carrying at least one fishing rod and reel and related accessories and equipment. The carry bag has an overall length to accommodate most standard sizes of fishing rods.

The present invention more particularly comprises A fishing rod carry bag for the transport of a fishing rod and reel, comprising:

an elongated bag having a first end and a second end, wherein said bag is open for receipt of said fishing rod therethrough, said enclosure bag being defined by a first and a second multilayer sidewall;

a unitary compartment located in the interior of said elongated bag, arranged to protectively enclose said fishing rod, said unitary compartment formed within an inner lining of said bag; and

an exterior portion of said bag comprising a material that is resistant to cuts, punctures and water.

The fishing rod carry bag of comprises an inner lining is formed from PVC material and an outer layer formed from material comprising polyester 600D.

The fishing rod carry bag has a unitary compartment that is free from straps or other securing devices for securing rods into a fixed position within the compartment. The present invention improves upon other bags that have been viewed as cumbersome in having pockets, compartments, straps and other features in the inner compartment.

In one embodiment, the fishing rod carry bag further comprises a handle arranged on an upper edge of said elongated bag at a mid-point thereof to permit one-handed carrying thereof.

In another embodiment, the fishing rod carry bag of claim further comprises an elongated shoulder strap attached at two points to said carry bag to permit carrying of said bag by one's shoulder. The bag may comprise either the handle, the shoulder strap, or the handle and shoulder strap.

Further contemplated is a method of transporting a fishing rod comprising the steps of:
(a) opening a fishing rod carry bag of an elongated bag having:

a first end and a second end, wherein said bag is open for receipt of said fishing rod therethrough, said enclosure bag being defined by a first and a second multilayer sidewall;

a unitary compartment located in the interior of said elongated bag, arranged to protectively enclose said fishing rod, said unitary compartment formed within an inner lining of said bag; and

an exterior portion of said bag comprising a material that is resistant to cuts, punctures and water;

the fishing rod carry bag of comprises an inner lining is formed from PVC material and an outer layer formed from material comprising polyester 600D., wherein said carry bag is resistant to cuts, and puncture from fishing hooks or other sharp objects;
(b) placing fishing rod into said carry bag; and
(c) closing said carry bag.

The elongated bag has an elongated zipper extends substantially from one end of the uppermost edge of the elongated bag to the second or distalmost end of the elongated bag.

The carry bag has a carrying handle arranged across its uppermost edge on a second sidewall thereof, and at a midpoint thereof for carrying the bag by a single hand. The elongated bag also has an elongated shoulder strap extending from an upper edge thereof at the first end to an upper edge thereof at the second end. The shoulder strap may be on the same side of the bag as the carrying handle, or may be on a different side.

In one embodiment the unitary inner compartment is defined by a first sidewall and the second sidewall with an elongated strip of material comprising a curvilinear lowermost wall. The elongated support bag is about three to four inches in width along its entire length, sufficient to enclose a reel of up to approximately 8 inches in diameter and several inches thick, within that pouch.

In yet a further embodiment of the present invention, at least a portion of the sidewalls of the elongated support bag are water impervious and may have floatation material therebetween, so as to act as a floatation device for the contents of the elongated support bag, (or fisherman) should that be necessary.

Thus, what has been shown is a unique and safe enclosure and carry bag for a fishing rod and reel and its associated equipment and accessories.

### BRIEF DESCRIPTION OF THE DRAWINGS

FIG. 1 is a perspective view of the bottom of the carry bag

FIG. 2 is a perspective view of the side and top of the carry bag.

### DESCRIPTION OF THE PREFERRED EMBODIMENTS

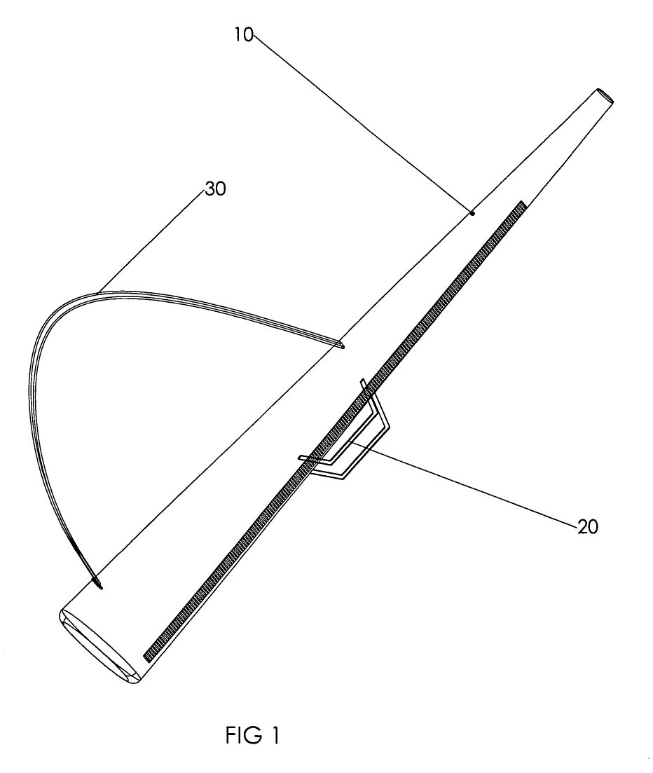

Referring now to the drawings in detail, and particularly to FIG. 1, there is shown the present invention which comprises a fishing rod and reel carry bag 10 for enclosing and carrying at least a major portion of a fishing rod, reel and related accessories and equipment. The carry bag 10 is made from a flexible material such as polyester 600D or the like, having an overall length suitable for carrying a desired fishing rod. The carry bag 10 is asymmetrical along the length of its longitudinal axis.

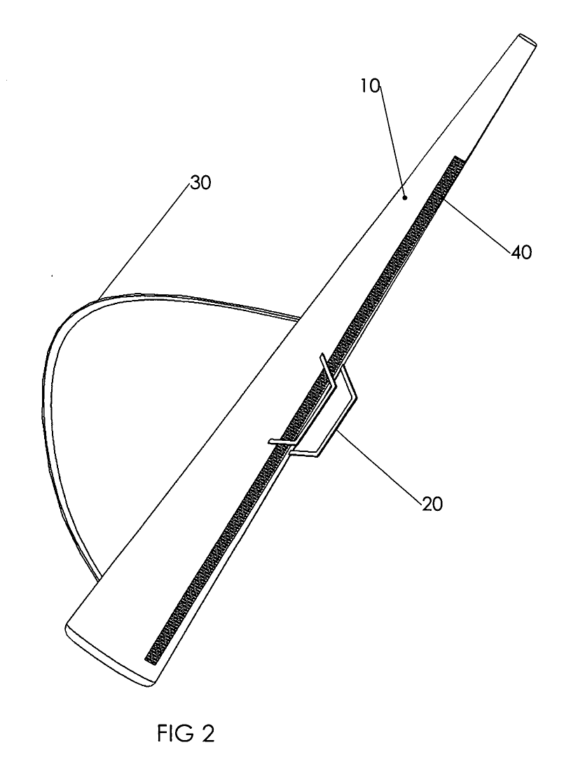

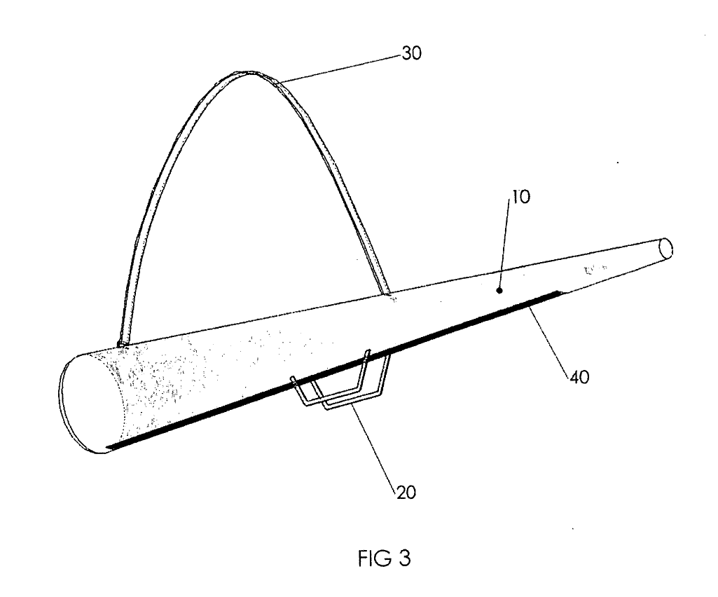

The elongated bag 10 has a carry handle 20 arranged across its uppermost edge, as shown in FIGS. 1 and 2. at a midpoint thereof for carrying the bag 10 by a single hand. The carry bag 10 also has an elongated shoulder strap 30 whereby the carry bag may be carried by using the shoulder strap 30.

FIG. 2 further shows the carry bag of the present invention whereby a zipper 40 is used to access and secure the contents of the unitary inner compartment. Because the inner compartment is unitary and free from pouches, dividers, straps and the like, the possibility of these items interfering with the closure of the zipper 40 is eliminated.

Thus, what has been shown is a unique and safe enclosure and carrying a fishing rod and reel and its associated equipment and accessories. The carry bag permits the safe support and carrying of those devices to the fishing site in an appropriate manner.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A fishing rod carry bag for the transport of a fishing rod and reel, comprising:
an elongated bag having a first end and a second end, wherein said bag is open for receipt of said fishing rod therethrough;
a unitary compartment located in the interior of said elongated bag, arranged to protectively enclose said fishing rod, said unitary compartment formed within an inner lining of said bag formed of PVC; and
an exterior portion of said bag formed of polyester 600D comprising a material that is resistant to cuts, punctures and water.

2. (canceled)

3. (canceled)

4. The fishing rod carry bag of claim 1, wherein said unitary compartment is free from straps or other securing devices for securing rods into a fixed position within the compartment.

5. The fishing rod carry bag of claim 1, further comprising a handle arranged on an upper edge of said elongated bag at a mid-point thereof to permit one-handed carrying thereof.

6. The fishing rod carry bag of claim 1, further comprising an elongated shoulder strap attached at two points to said carry bag to permit carrying of said bag by one's shoulder.

7. A method of transporting a fishing rod comprising the steps of:
(a) opening a fishing rod carry bag of claim 1, wherein said carry bag is resistant to cuts, and puncture from fishing hooks or other sharp objects;
(b) placing fishing rod into said carry bag; and
(c) closing said carry bag.
